(19) United States
(12) Patent Application Publication
(10) Pub. No.: US 2022/0360517 A1
(43) Pub. Date: Nov. 10, 2022

(54) SCHEDULING VIRTUAL USERS BASED ON CURVE FITTING

(71) Applicant: MICRO FOCUS LLC, SANTA CLARA, CA (US)

(72) Inventors: DONG-XING HUANG, SHANGHAI (CN); ER-XIN SHANG, SHANGHAI (CN); YAN YANG, SHANGHAI (CN)

(73) Assignee: MICRO FOCUS LLC, SANTA CLARA, CA (US)

(21) Appl. No.: 17/623,851

(22) PCT Filed: Jul. 23, 2019
(86) PCT No.: PCT/CN2019/097184

§ 371 Date: Dec. 29, 2021

(51) Int. Cl. H04L 43/55; H04L 43/045

(52) U.S. Cl. CPC H04L 43/55; H04L 43/045

(57) ABSTRACT

According to examples, an apparatus may include a processor that may schedule virtual users in a load test of a system under test. An apparatus may access user-specified or prestored points. Each point may represent a number of virtual users that is to place a load on the system under test at a given time. The apparatus may apply curve fitting, such as Bézier curve fitting, to generate a curve on a graph in which one axis represents time and another axis represents a number of virtual users at a given time. In some examples, the apparatus may use a smoothing factor to adjust the contours of the generated curve. The apparatus may use the curve to determine curve-fitted points to schedule virtual users at times corresponding to the curve-fitted points. To instantiate the virtual users, the system may use coroutines to reduce computational requirements for instantiating the virtual users.

### BACKGROUND

Various testing applications have been developed to assess system behaviour and performance under load. These testing applications may generate concurrent simulated users to simulate the load on a system under test. To do so, the testing applications may generate a load test schedule in which a number of simulated users may be scheduled over time. The simulated users may perform various actions such as submitting requests to applications running on the system for which the behaviour and performance under load is being tested or otherwise placing a load on the system.

### BRIEF DESCRIPTION OF THE DRAWINGS

Features of the present disclosure may be illustrated by way of example and not limited in the following figure(s), in which like numerals indicate like elements, in which:

FIG. 1 shows a block diagram of an example apparatus that may schedule virtual users for load testing a system under test;

FIG. 2 shows an example of a system for scheduling virtual users for load testing the system under test;

FIG. 3A shows an example of a graph to receive an input of a plurality of points for scheduling virtual users;

FIG. 3B shows an example of graphically representing a curve that is generated from curve-fitting the plurality of points for scheduling virtual users;

FIG. 3C shows an example of altering the curve based on a change in the plurality of points for scheduling virtual users;

FIG. 3D shows an example of curve-fitted points on the curve and indicators of the number of virtual users during a load test;

FIG. 4 shows an example of a time interval between points on the curve for determining whether to alter the number of virtual users;

FIG. 5 depicts a flow diagram of an example method for graphically representing a curve for scheduling virtual users for a load test; and

FIG. 6 depicts a block diagram of an example non-transitory machine-readable storage medium for importing previously specified points for generating a curve to schedule virtual users for a load test.

### DETAILED DESCRIPTION

For simplicity and illustrative purposes, the present disclosure may be described by referring mainly to examples. In the following description, numerous specific details are set forth in order to provide a thorough understanding of the present disclosure. It will be readily apparent however, that the present disclosure may be practiced without limitation to these specific details. In other instances, some methods and structures have not been described in detail so as not to unnecessarily obscure the present disclosure. Throughout the present disclosure, the terms “a” and “an” may be intended to denote at least one of a particular element. As used herein, the term “includes” means includes but not limited to, the term “including” means including but not limited to. The term “based on” means based at least in part on.

A problem that may arise out of automated and simulated load testing is that it may be difficult to generate the load test schedule. For instance, a (human) load tester may be required to configure the load test schedule by inputting each number of simulated users (also referred to herein as “virtual users” or “vusers”) to be scheduled at a given time or may schedule the same number of virtual users throughout the duration of the load test, either of which may not be complex enough to simulate real-world conditions. A virtual user may include an application or process that executes various activities on the system under test to simulate computational load imposed by real-world activity on the system under test.

Disclosed herein are apparatuses and methods for scheduling virtual users in a load test of a system under test. For example, an apparatus may access a plurality of points in which each point of the plurality of points represents a number of virtual users that is to place a load on the system under test at a given time. The apparatus may apply curve fitting to generate a curve, such as a best-fit curve, based on the plurality of points. One example of a curve fitting technique may include Bézier curve fitting, although the apparatus may use other curve fitting techniques as well. In some examples, the apparatus may use a smoothing factor to adjust the contours of the generated curve. The smoothing factor may be received from a load test designer.

The apparatus may use the curve to schedule virtual users. For example, the apparatus may use the curve to determine curve-fitted points (points along the curve other than the plurality of points from which the curve was generated) to schedule virtual users at times corresponding to the curve-fitted points. Because the plurality of points may be selected (by a human load test designer) to simulate real-world conditions at specified points in time and because the apparatus may automatically determine curve-fitted points to generate the load test schedule, the apparatus may simulate complex real-world conditions for load testing.

In some examples, the apparatus may access the plurality of points via a graphical user interface (GUI)-based graph that represents a load test schedule. A first axis (such as the x-axis) of the graph may represent time and a second axis (such as the y-axis) may represent a number of virtual users to be scheduled at a given point in time. A load test designer may plot the plurality of points on the graph via a GUI. The apparatus may then apply curve fitting to generate the curve and determine curve-fitted points along the curve. In some examples, the apparatus may access the plurality of points from a load test datastore. The load test datastore may store a historical set of points used for curve fitting in previous load tests.

In some examples, the apparatus may receive a modification to the plurality of points received via input at the graph or imported from the load test datastore. The modification may include a deletion, addition, or change to an existing point of the plurality of points. For example, a user may delete a point, add a point, or move a point plotted on the graph. After the modification to the plurality of points, the apparatus may generate (or re-fit) a curve based on the modified plurality of points.

In some examples, the number of virtual users instantiated to simulate load on the system under test may impose a computational burden (such as processing resources, memory resources, and the like) on the apparatus or other virtual user scheduler that instantiates the virtual users. To mitigate the load, the apparatus may use coroutines. Coroutines may be scheduled in user space and have flexible stack space. Coroutines may therefore enable a larger scale of virtual users since the coroutines may use less system resources.

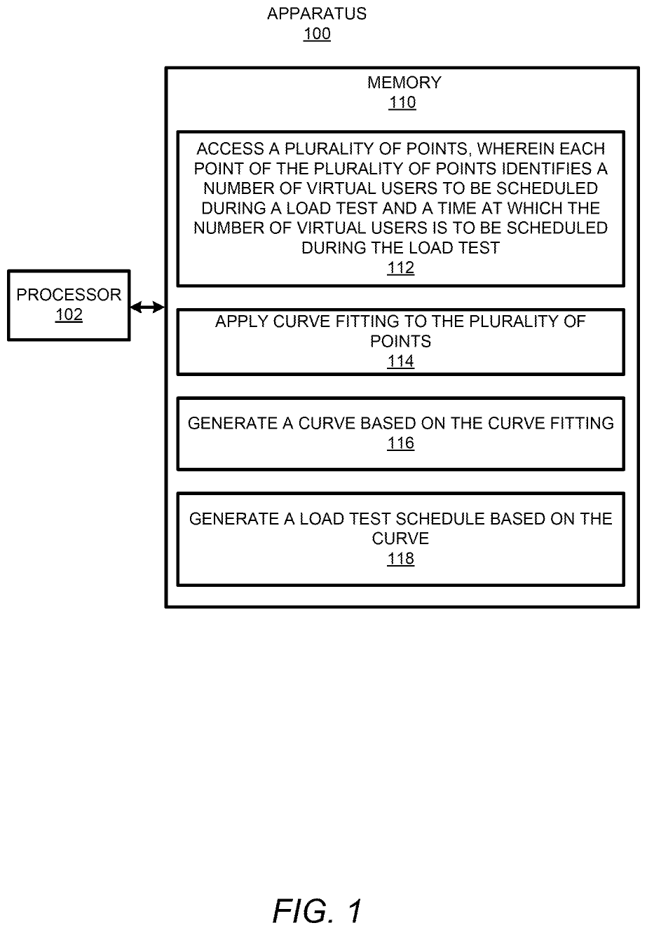

FIG. 1 shows a block diagram of an example apparatus that may schedule virtual users for a load test based on curve-fitting a plurality of points that represent a number of virtual users to be scheduled at a given point in time during the load test. It should be understood that the example apparatus 100 depicted in FIG. 1 may include additional features and that some of the features described herein may be removed and/or modified without departing from any of the scopes of the example apparatus 100. The apparatus 100 shown in FIG. 1 may be a computing device, a server, or the like. As shown in FIG. 1, the apparatus 100 may include a processor 102 that may control operations of the apparatus 100. The processor 102 may be a semiconductor-based microprocessor, a central processing unit (CPU), an application specific integrated circuit (ASIC), a field-programmable gate array (FPGA), and/or other suitable hardware device. Although the apparatus 100 has been depicted as including a single processor 102, it should be understood that the apparatus 100 may include multiple processors, multiple cores, or the like, without departing from the scopes of the apparatus 100 disclosed herein.

The apparatus 100 may include a memory 110 that may have stored thereon machine-readable instructions (which may also be termed computer readable instructions) 112-118 that the processor 102 may execute. The memory 110 may be an electronic, magnetic, optical, or other physical storage device that includes or stores executable instructions. The memory 110 may be, for example, Random Access memory (RAM), an Electrically Erasable Programmable Read-Only Memory (EEPROM), a storage device, an optical disc, and the like. The memory 110 may be a non-transitory machine-readable storage medium, where the term “non-transitory” does not encompass transitory propagating signals.

Referring to FIG. 1, the processor 102 may fetch, decode, and execute the instructions 112 to access a plurality of points. Each point of the plurality of points may identify a number of virtual users to be scheduled during a load test and a time at which the number of virtual users is to be scheduled during the load test. To access the plurality of points, the processor 102 may import the plurality of points from a previous load test. In some examples, to access the plurality of points, the processor 102 may generate a graphical user interface (GUI) comprising a graph through which the plurality of points is received via user input to the graph. A first axis on the graph (such as the y-axis) may represent the number of virtual users to be scheduled, and the second axis (such as the x-axis) may represent the time at which the number of virtual users is to be scheduled. The processor 102 may display the curve on the graph. In other words, the processor 102 may include the curve on the graph.

The processor 102 may fetch, decode, and execute the instructions 114 to apply curve fitting to the plurality of points. One example of a curve fitting technique may include Bézier curve fitting, although the apparatus may use other curve fitting techniques as well. In some examples, the process of curve fitting may include determining points other than the plurality of points along a curve that fits the plurality of points. Such points other than the plurality of points will be referred to herein as “curve-fitted points.”

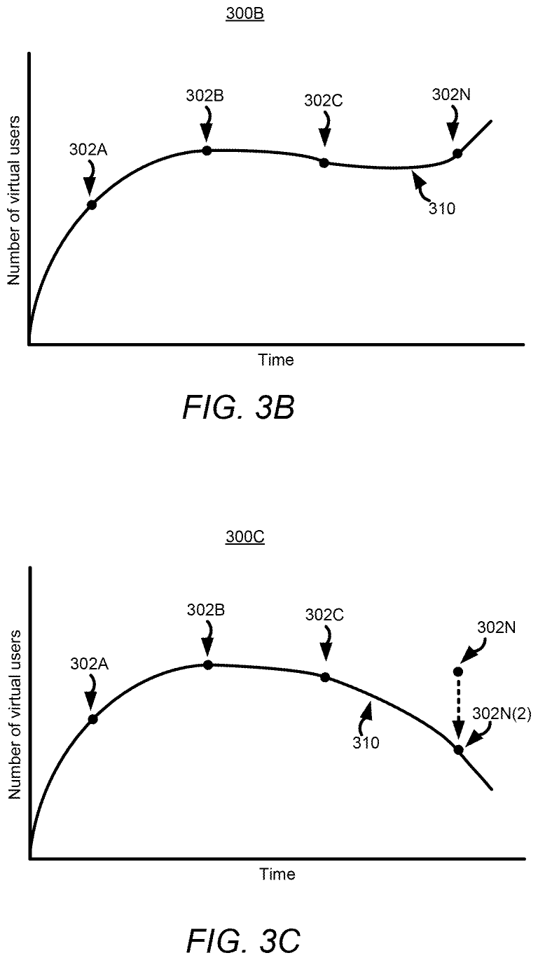

The processor 102 may fetch, decode, and execute the instructions 116 to generate a curve (such as curve 310 illustrated in FIGS. 3B-D) based on the curve fitting. The curve may be a representation of the collective set of some or all of the curve-fitted points and some or all of the plurality of points. The representation may include a mathematical function, which may be based on Bernstein polynomials.

In some examples, the curve may include a Quadratic Bezier curve in which the processor 102 may use the plurality of points (such as points 302A-N illustrated in FIG. 3A) to bend the curve based on the positions of the plurality of points to trace the curve along the points. In this example, the processor 102 may bend the curve starting from the first point (such as point 302A) in the plurality of points toward the next point (such as point 302B) in the plurality of points, and repeat until the last point (such as point 302N) in the plurality of points is reached. In some of these examples, the middle points (such as points 302B and 302C) of the plurality of points may lie on the generated curve. In some of these examples, the middle points of the plurality of points may not lie on the generated curve. In some examples, the curve may include a Cubic Bezier curve in which the processor 102 may use the plurality of points 302A-N to bend the curve based on the positions of the plurality of points to trace the curve along the points. In some of these examples, the processor 102 may use the middle points (such as points 302B and 302C) of the plurality of points as merely directional guides for the curve and therefore some or all of the middle points may not lie on the generated curve.

In some examples, the processor 102 may graphically represent the curve in a GUI by plotting some or all of the curve-fitted points and some or all of the plurality of points. In some examples, the processor 102 may access and use a smoothing factor to generate the curve or otherwise adjust the contours of the generated curve. The smoothing factor may be received from a load test designer.

The processor 102 may fetch, decode, and execute the instructions 118 to generate a load test schedule based on the curve. For example, to generate the load test schedule, the processor 102 may determine a plurality of curve-fitted points based on the curve. The load test schedule may be generated based on the plurality of curve-fitted points from the curve.

In some examples, the processor 102 may conduct a load test based on the load test schedule. In some examples, the processor 102 may determine a current number of virtual users during the load test and generate, in the graph, an indication of the number of virtual users currently in the load test. In some examples, the processor 102 may access a modification to the plurality of points and refit the curve based on the modification to the plurality of points. In these examples, the processor 102 may modify the load test schedule based on the refit curve.

In some examples, the processor 102 may conduct the load test by executing a virtual user according to the load test schedule. For example, the processor 102 may schedule a number of virtual users at a given time based on a point along the curve in the graph. In some examples, to mitigate computational load imposed by the virtual user, the processor 102 may execute the virtual user using a coroutine. Coroutines may be scheduled in user space and have flexible stack space. Coroutines may therefore enable a larger scale of virtual users since the coroutines may use less system resources.

In some examples, the processor 102 may access an indication of a number of instances that virtual users are to be scheduled during the load test. The number of the plurality of curve-fitted points may be determined based on the number of instances. For example, a load test designer may specify that fifty points be used during a load test. The processor 102 may accordingly select fifty points along the curve to instantiate virtual users. The processor 102 may space the fifty points substantially evenly across the load test such that an interval between any two adjacent points in the curve is substantially equal to another interval between two other adjacent points.

In some examples, the processor 102 may determine a first number of virtual users to be scheduled associated with a first curve-fitted point of the plurality of curve-fitted points. The processor 102 may determine a second number of virtual users to be scheduled associated with a second curve-fitted point of the plurality of curve-fitted points. The second curve-fitted point may be adjacent to the first curve-fitted point in the plurality of curve-fitted points on the curve. The processor 102 may determine whether to add or remove a virtual user in an interval between the first curve-fitted point and the second curve-fitted point based on the first number and the second number.

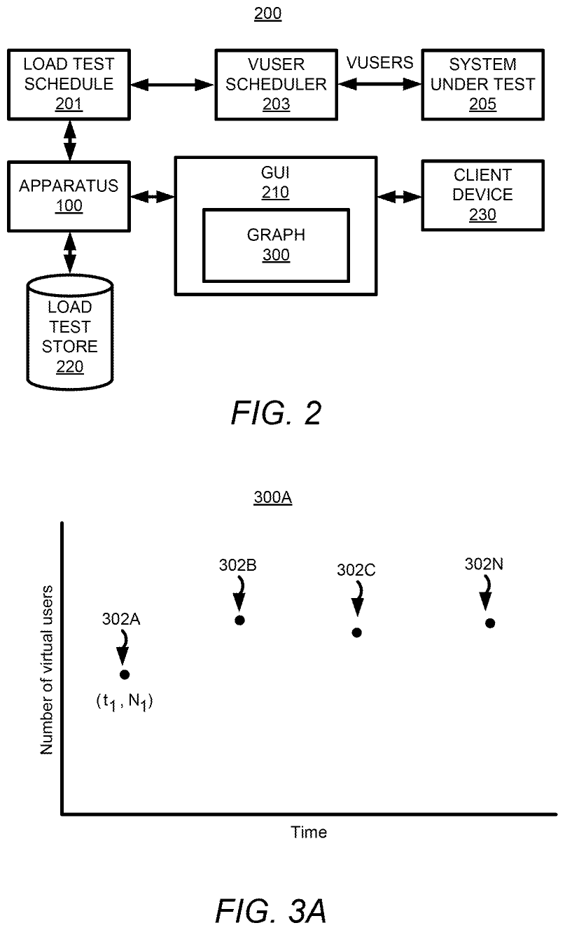

In some examples, the apparatus 100 may be part of a system 200 for scheduling virtual users for load testing. For example, FIG. 2 shows an example of a system 200 for scheduling virtual users for load testing the system under test 205. The system 200 may include the apparatus 100, a vuser scheduler 203, the system under test 205, a load test store 220, a client device 230, and/or other components. The apparatus 100 may generate a GUI 210, which may include a graph 300. Various examples of the graph 300 are further illustrated as graphs 300A-D in FIGS. 3A-D. The graph 300 may display the curve, which may be generated as described herein. FIG. 3A shows an example of a graph 310 to receive an input of a plurality of points 302A-N for scheduling virtual users. FIG. 3B shows an example of graphically representing a curve 310 that is generated from curve-fitting the plurality of points 302A-N for scheduling virtual users. FIG. 3C shows an example of altering the curve 310 based on a change in the plurality of points 302A-N for scheduling virtual users. FIG. 3D shows an example of curve-fitted points 312A and B on the curve 310 and indicators 320A-N that may serve as visual indicators of telemetry information that specifies the number of virtual users during a load test.

In some examples, the graph 300 (or other portion of the GUI 210) may receive user input that specifies locations in the graph 300 corresponding to a plurality of points that the apparatus 100 accesses. The user input may include GUI interactions such as a point, a click, and/or other inputs to the graph 300 that may specify a location on the graph at which a point is to be created. The user input may be provided from the client device 230, which may receive and display the GUI 210 (and graph 300) to a user, such as a load test designer. In these examples, the apparatus 100 may access the plurality of points based on the user input.

In some examples, the apparatus 100 may access the plurality of points from the load test store 220. The load test store 220 may store previously specified (and/or used) points for curve-fitting in previous load tests. In this manner, a load test designer may select previously-used points for curve-fitting. In some of these examples, the load test designer may modify the previously-used points by removing, adding, or moving a point in the previously-used points.

Regardless of the manner in which the apparatus 100 may access the plurality of points 302, the apparatus 100 may apply curve-fitting on the plurality of points 302 to generate a curve 310 (examples of which are illustrated in FIGS. 3B-3D). The apparatus 100 may generate a load test schedule 201 based on the curve 310. In a particular example, the apparatus 100 may apply the curve-fitting function to obtain an array of values that correspond to curve-fitted points on the curve. The array of values may include some or all of the plurality of points 302 as well. Each value of the array of values may represent a point along the curve and therefore indicate a number of virtual users to be scheduled at a given time. The apparatus 100 may generate the load test schedule 201 based on the array of values.

The load test schedule 201 may include a schedule of the number of virtual users that are to be instantiated over time. For example, the load test schedule 201 may include a plurality of entries corresponding to points along the curve 310. In other words, each entry in the load test schedule 201 may correspond to a point on the curve 310. The point on the curve may include a point among the plurality of points 302 or a point among the curve-fitted points 312. Each point on the curve may correspond to a number of virtual users to be scheduled (according to the y-axis of the graph 300) at a given time (according to the x-axis of the graph 300). As such, the apparatus 100 may generate each entry in the load test schedule 201 to specify a number of virtual users that is to run at a given point in time during a load test.

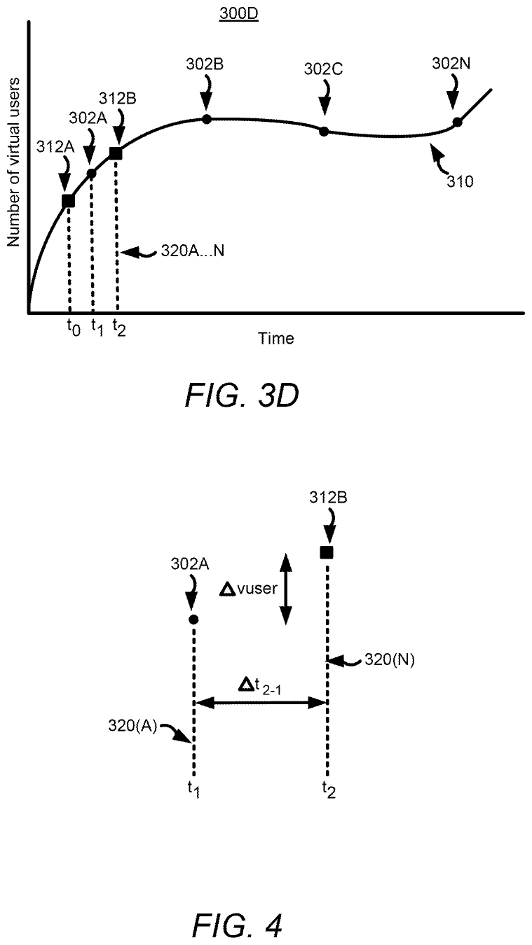

For example, referring to FIG. 4, at a given time interval (illustrated as Δt₂₋₁) between two points (illustrated as a fitted point 312B and a point 302A, although other points and types of points on the curve may be used) on the curve, the apparatus 100 may determine that the number of vusers is to increase from time t₁ to time t₂ based on the position of the point 302A on the y-axis and the position of the point 312B on the y-axis. The apparatus 100 may represent such increase in various ways. In one example, the apparatus 100 may include absolute numbers of vusers at a given point in time such that the vuser scheduler 203 determines whether to increase, decrease, or keep the same the number of vusers from one point in time to the next point in time. In another example, the apparatus 100 may include a delta value in a given entry of the load test schedule 201 that indicates a number of vusers that should be added (e.g., a positive number), decreased (e.g., a negative number), or remain the same (e.g., zero).

In some examples, the apparatus 100 may provide the generated load test schedule 201 to a vuser scheduler 203 to conduct the load test based on the load test schedule. The vuser scheduler 203 may conduct the load test by analyzing the load test schedule 201 and increasing, decreasing, or keeping the same number of virtual users from one time point to another during the load test.

It should be noted that the vuser scheduler 203 is illustrated as being separate from the apparatus 100 in FIG. 2 for illustrative convenience. It should be understood that the apparatus 100 may include the functions of the vuser scheduler 203. That is, the processor 102 of the apparatus 100 may fetch, decode, and execute instructions stored in the memory 110 to perform the functions of the vuser scheduler 203 described herein.

Some of the curve-fitted points 312 may be interpolated based on points 302. For example, curve-fitted point 312B may be interpolated based on points 302A and 302B in which the position of the curve-fitted point 312B may be based on the positions of points 302A and 302B. Some of the curve-fitted points 312 may be extrapolated. For example, a curve-fitted point 312A may be extrapolated based on only a single point 302A. In this example, the curve-fitting function may determine the position of the curve-fitted point 312A by using the position of the single point 302A.

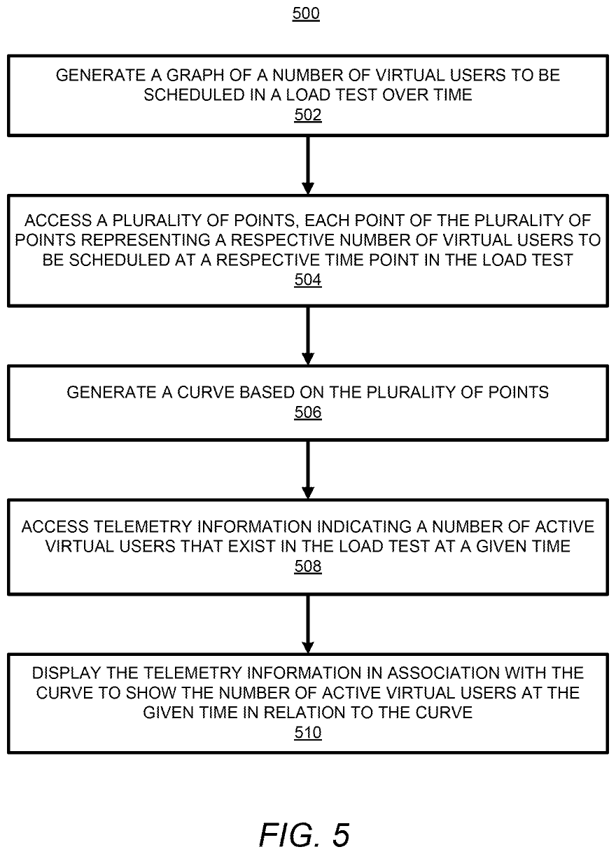

Having described curve-fitting to generate a load test schedule, an example of graphically representing the curve will now be described with reference to FIG. 5. FIG. 5 depicts a flow diagram of an example method 500 for graphically representing a curve for scheduling virtual users for a load test. Various manners in which the apparatus 100 may operate to search a document index generated as disclosed herein are discussed in greater detail with respect to the method 500 depicted in FIG. 5. It should be understood that the method 500 may include additional operations and that some of the operations described therein may be removed and/or modified without departing from the scopes of the method 500. The description of the method 500 may be made with reference to the features depicted in FIGS. 1-4 for purposes of illustration.

As shown in FIG. 5, at block 502, the processor 102 may generate a graph, such as graph 300, of a number of virtual users to be scheduled in a load test over time.

At block 504, the processor 102 may access a plurality of points, such as points 302 illustrated in FIGS. 3A-D. Each point of the plurality of points 302 may represent a respective number of virtual users to be scheduled at a respective time point in the load test. For example, the processor 102 may receive a user input from a load test designer that specifies the plurality points. The user input may be received via a graph, such as graphs 300A-D (respectively illustrated in FIGS. 3A-3D), that plots the plurality of points 302. In some examples, the plurality of points 302 may be accessed from predefined set of points that was previously used for a previous load test.

For example, the plurality of points 302 may be stored at a datastore, such as the load test store 220. In some examples, the processor 102 may access a user input that modifies the predefined set of points (or user input points from a graph) and modify the plurality of points based on the user input. The modification to the plurality of points may impact generation of the curve and/or cause the curve to be refit to the modified plurality of points, such as illustrated in FIGS. 3B and 3C. For example, moving point 302N from a position illustrated in FIG. 3B to a position illustrated in FIG. 3C may result in a refitting of the curve 310. Thus, the curve 310 illustrated in FIG. 3C may be adjusted based on the modification to the plurality of points 302. In this manner, a load test designer may modify a load test by modifying points on the graph or otherwise modifying the plurality of points used for curve-fitting. Such modifications may include adding points, deleting points, and/or moving points.

At block 506, the processor 102 may generate a curve (such as curve 310 illustrated in FIGS. 3B, 3C, and 3D) based on the plurality of points. Curve generation may include creating a representation of the curve in the graph and/or otherwise obtaining an output of curve-fitting that produces an array of values that represent points along a curve if the points were plotted in the graph.

At block 508, the processor 102 may access telemetry information indicating a number of active virtual users that exist in the load test at a given time. For example, the telemetry information may be provided by the vuser scheduler 203, which may conduct the load test and instantiate the virtual users during the load test.

At block 510, the processor 102 may display the telemetry information in association with the curve to show the number of active virtual users at the given time in relation to the curve.

In some examples, the processor 102 may forward the plurality of points to a virtual user scheduler (such as vuser scheduler 203 illustrated in FIG. 2) that generates a curve to fit the plurality of points. The curve may be used to generate a load test schedule that schedules virtual users.

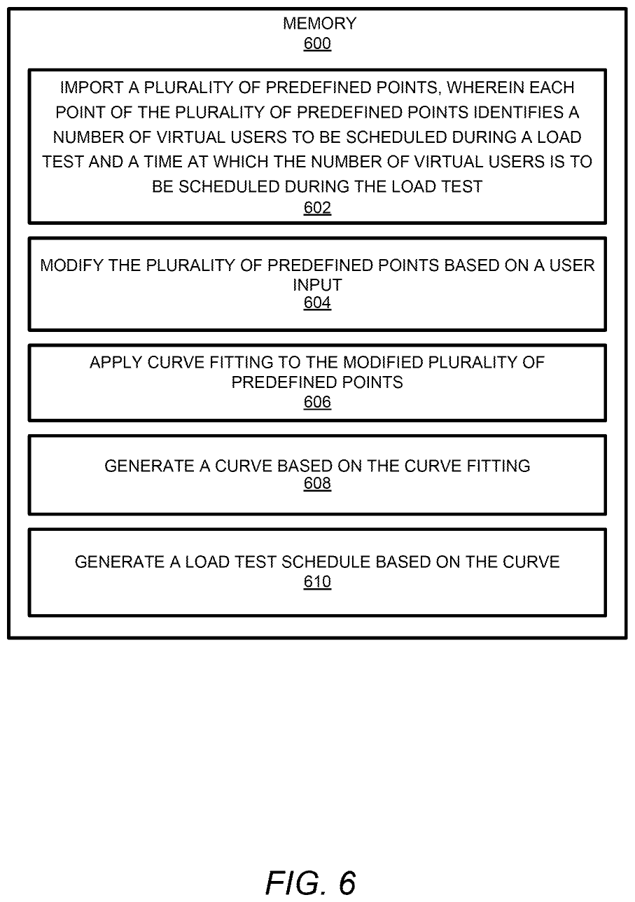

FIG. 6 depicts a block diagram of an example memory 600 for importing previously specified points for generating a curve to schedule virtual users for a load test. The memory 600 may be an electronic, magnetic, optical, or other physical storage device that includes or stores executable instructions. The memory 600 may be a non-transitory machine-readable storage medium, where the term “non-transitory” does not encompass transitory propagating signals. The memory 600 may be, for example, Random Access memory (RAM), an Electrically Erasable Programmable Read-Only Memory (EEPROM), a storage device, an optical disc, and the like. The memory 600 may have stored thereon machine-readable instructions 602-610 that a processor, such as the processor 102, may execute.

The machine-readable instructions 602 may cause the processor to import a plurality of predefined points. Each point of the plurality of predefined points may identify a number of virtual users to be scheduled during a load test and a time at which the number of virtual users is to be scheduled during the load test.

The machine-readable instructions 604 may cause the processor to modify the plurality of predefined points based on a user input. The machine-readable instructions 606 may cause the processor to apply curve fitting to the modified plurality of predefined points. The result of such curve-fitting, in some examples, may be to generate curve-fitted points based on a curve-fitting technique. The machine-readable instructions 608 may cause the processor to generate a curve based on the curve fitting. The machine-readable instructions 610 may cause the processor to generate a load test schedule based on the curve.

Although described specifically throughout the entirety of the instant disclosure, representative examples of the present disclosure have utility over a wide range of applications, and the above discussion is not intended and should not be construed to be limiting, but is offered as an illustrative discussion of aspects of the disclosure.

What has been described and illustrated herein is an example of the disclosure along with some of its variations. The terms, descriptions and figures used herein are set forth by way of illustration only and are not meant as limitations. Many variations are possible within the spirit and scope of the disclosure, which is intended to be defined by the following claims—and their equivalents—in which all terms are meant in their broadest reasonable sense unless otherwise indicated.

What is claimed is:

1. An apparatus comprising:
a processor; and
a non-transitory computer readable medium on which is stored instructions that when executed by the processor, are to cause the processor to:
access a plurality of points, wherein each point of the plurality of points identifies a number of virtual users to be scheduled during a load test and a time at which the number of virtual users is to be scheduled during the load test;
apply curve fitting to the plurality of points;
generate a curve based on the curve fitting; and
generate a load test schedule based on the curve.

2. The apparatus of claim 1, wherein the instructions are further to cause the processor to:
conduct a load test based on the load test schedule.

3. The apparatus of claim 2, wherein to conduct the load test, the instructions are further to cause the processor to:
execute a virtual user according to the load test schedule using a coroutine.

4. The apparatus of claim 2, wherein to generate the load test schedule based on the curve, the instructions are further to cause the processor to:
determine a plurality of curve-fitted points based on the curve, wherein the load test schedule is generated based on the plurality of curve-fitted points.

5. The apparatus of claim 4, wherein to determine the plurality of points, the instructions are further to cause the processor to:
access an indication of a number of instances that virtual users are to be scheduled during the load test, wherein a number of the plurality of curve-fitted points is determined based on the number of instances.

6. The apparatus of claim 4, wherein to generate the load test schedule, the instructions are further to cause the processor to:
determine a first number of virtual users to be scheduled associated with a first curve-fitted point of the plurality of curve-fitted points;
determine a second number of virtual users to be scheduled associated with a second curve-fitted point of the plurality of curve-fitted points, the second curve-fitted point adjacent to the first curve-fitted point in the plurality of curve-fitted points; and
determine whether to add or remove a virtual user in an interval between the first curve-fitted point and the second curve-fitted point based on the first number and the second number.

7. The apparatus of claim 1, wherein to access the plurality of points, the instructions are further to cause the processor to:
import the plurality of points from a previous load test.

8. The apparatus of claim 1, wherein to access the plurality of points, the instructions are further to cause the processor to:
generate a graphical user interface (GUI) comprising a graph, wherein the plurality of points is received via user input to the graph.

9. The apparatus of claim 8, wherein a first axis on the graph represents the number of virtual users to be scheduled, and the second axis represents the time at which the number of virtual users is to be scheduled.

10. The apparatus of claim 8, wherein the instructions are further to cause the processor to:
display the curve on the graph.

11. The apparatus of claim 8, wherein the instructions are further to cause the processor to:
conduct a load test based on the load test schedule;
determine a current number of virtual users during the load test; and
generate, in the graph, an indication of the number of virtual users currently in the load test.

12. The apparatus of claim 8, wherein the instructions are further to cause the processor to:
conduct a load test based on the load test schedule;
access a modification to the plurality of points;
refit the curve based on the modification to the plurality of points; and
modify the load test schedule based on the refit curve.

13. The apparatus of claim 1, wherein to generate the curve, the instructions are further to cause the processor to:
access a smoothing factor; and
apply the smoothing factor to the curve fitting function.

14. A method comprising:
generating, by a processor, a graph of a number of virtual users to be scheduled in a load test over time;
accessing, by the processor, a plurality of points, each point of the plurality of points representing a respective number of virtual users to be scheduled at a respective time point in the load test;
generating, by the processor, a curve based on the plurality of points;
accessing, by the processor, telemetry information indicating a number of active virtual users that exist in the load test at a given time; and
displaying, by the processor, the telemetry information in association with the curve to show the number of active virtual users at the given time in relation to the curve.

15. The method of claim 14, wherein accessing the plurality of points comprises:
accessing a user input to the graph that specifies the plurality of points.

16. The method of claim 15, further comprising:
forwarding the plurality of points to a virtual user scheduler that generates a curve to fit the plurality of points, wherein the curve is used to generate a load test schedule that schedules virtual users.

17. The method of claim 14, wherein accessing the plurality of points comprises:
accessing a predefined set of points.

18. The method of claim 17, further comprising:
accessing a user input that modifies the predefined set of points; and
modifying the plurality of points based on the user input.

19. A non-transitory computer readable medium on which is stored machine readable instructions that when executed by a processor, cause the processor to:
import a plurality of predefined points, wherein each point of the plurality of predefined points identifies a number of virtual users to be scheduled during a load test and a time at which the number of virtual users is to be scheduled during the load test;
modify the plurality of predefined points based on a user input;
apply curve fitting to the modified plurality of predefined points;
generate a curve based on the curve fitting; and
generate a load test schedule based on the curve.

20. The non-transitory computer readable medium of claim 19, wherein to modify the plurality of predefined points, the machine readable instructions, when executed, further cause the processor to:
cause a load test to be conducted based on the load test schedule.
